(19) United States
(12) Patent Application Publication
(10) Pub. No.: US 2014/0295825 A1
(43) Pub. Date: Oct. 2, 2014

(54) NETWORK DIVERSITY BASED ERROR REPORTING METHOD AND USER EQUIPMENT USING THE SAME

(71) Applicant: Acer Incorporated, New Taipei City (TW)

(72) Inventors: Ming-Dao Chuang, New Taipei City (TW); Shiang-Rung Ye, New Taipei City (TW)

(73) Assignee: Acer Incorporated, New Taipei City (TW)

(21) Appl. No.: 14/105,194

(22) Filed: Dec. 13, 2013

Related U.S. Application Data
(60) Provisional application No. 61/806,403, filed on Mar. 29, 2013.

(51) Int. Cl. H04W 24/04; H04W 88/06

(52) U.S. Cl. CPC H04W 24/04; H04W 88/06
USPC 455/425; 455/553.1

(57) ABSTRACT

The present disclosure proposes a network diversity based error reporting method and a user equipment using the same method. The user equipment using the proposed method in the event of a network error would establish a first connection with a first network, establish a second connection with a second network which is a different type of network from the first network, establish a first failure report corresponding to the first connection in response to failing to connect with the first network, transmit through the second connection the first failure report to the second network in response to establishing the first failure report, establish a second failure report corresponding to the second connection in response to failing to connect with the second network, and transmit through the first connection the second failure report to the first network in response to establishing the second failure report.

### CROSS REFERENCE TO RELATED APPLICATION

This application claims the priority benefit of U.S. provisional application Ser. No. 61/806,403, filed on Mar. 29, 2013. The entirety of the above-mentioned patent application is hereby incorporated by reference herein and made a part of specification.

### TECHNICAL FIELD

The present disclosure proposes a network diversity based error reporting method and a user equipment using the same method.

### RELATED ART

Wireless communication has been a preeminent derivative of the most recent technological developments as users of wireless technologies are able to make calls and transmit data from anywhere in anytime and to choose from a variety of different types of networks at different locations or situations. At this point in time, because of the wide spread use of wireless communication technologies, not only is a town or a city expected to be blanketed by one or more wireless coverage but also a variety of different wireless networks has been deployed to assist a user to obtain network access. When a user brings a laptop or a cell phone away from home, the user would usually hop on to a network either through a cellular subscription such as 3G or through a Wi-Fi access point. Typically, a user could access a network through a Wi-Fi access point unless the user does not have the authorization to do so or is out of the signal range of the Wi-Fi access point. In that case, the user may choose to access a network through one's 3G subscription.

Subsequently, various means of wireless communications have been utilized to assist a mobile network operator to offload heavy data traffic in a densely populated areas. For example, small cell base stations such as femto or pico cell base stations have been deployed at various locations to offload heavy data traffic as well as remote radio heads (RRH) or wireless local area networks (WLAN). WLAN could be defined as a short to medium ranged network in which peer to peer or device to access point connections could be made under an established protocol such as IEEE 802.11. The access point could be a Wi-Fi hub which connects to a modem through which user equipments (UE) may connect to a core network and have access to the internet.

Recently, the interaction among various types of networks has been a hot topic since coordinated interaction may potentially assist a mobile network operator to offload data more effectively such that a user may experience faster and uninterrupted network connection and also the network infrastructure would be utilized more efficiently or evenly. Besides connection offloads initiated by a network, a user may also switch from one type of network connection to another network connection of a same or a different type because of device mobility. In the ebbs and flows of different devices connecting to various wireless networks, connection problems between devices and networks would inevitably occur. The problems, for example, could be the result of a user moving around and no longer receive adequate signal levels or could be the result of failures to offload. However, currently the error reporting mechanism may not yet be fully optimized.

Referring to FIG. 1 which illustrates a typical error report mechanism described under Long Term Evolution (LTE) wireless communication network specification RRC 36.331 as an example, a user equipment (UE) usually would only connect to one type of network at a time such that when there is a radio link problem with the one connection, there is no requirement for the UE to search for an alternative path to report the radio link problem immediately until the UE re-establishes the radio link connection with the network once again or until the UE changes its cell location.

To describe in more detail, in step S102, assuming that a UE 100 was previously connected to a base station 101 but a radio link failure suddenly occurs or the UE 100 could not connect to the base station 101 at all in the first place, the UE in response to the connection failure would in step S103 stores the information related to the radio link failure in VarRLF-Report. In step S104, assuming that the UE 100 can eventually re-establish the radio link with the base station 101, the UE would transmit a RRC Reestablishment Request to the base station 101. In response to receiving the RRC Reestablishment Request, in step S105 the base station 101 would reestablish the radio resource control (RRC) connection with the UE 101. In step S106, the UE 100 would transmit the RRC Connection Reestablishment Complete signaling to the base station 101. However, within the RRC Connection Reestablishment Complete signaling, the UE 100 would set an information element (IE) Rlf-InfoAvailable to TRUE if a connection failure has previously occurred. In response to seeing the bit Rlf-InfoAvailable set to TRUE, in step S107, the base station 101 would transmit a UE Information Request signaling to the UE 100 with the IE rlf-ReportReq set to TRUE. In step S108, the UE 100 in response would then transmit a UE Information Response signaling which includes the IE RLF-Report to the base station 101 and completes the error reporting.

The typical error reporting mechanism described by RRC 36.331 however suffers a few shortcomings. Since a UE 100 would not be required to immediately seek an alternative way to report radio link failures at its own volition, the network may not obtain information related to such failures in real time in order to perform network optimizations. Also without this knowledge, the network may not be able to prevent future data traffic offloads to this particular base station 101. Furthermore, other UEs under the domain of the base station 101 even though do not possess information related to the abovementioned radio link failures but may yet attempt to connect to the same base station 101 which is experiencing problems.

Based on the aforementioned shortcomings of a conventional error reporting mechanism, there would be a faster way to implement network error reporting which is closer to real time by taking advantage of network diversities which may become more and more prevalent and easily accessible.

### SUMMARY OF THE DISCLOSURE

Accordingly, the present disclosure is directed to proposes a network diversity based error reporting method and a user equipment using the same method.

A conventional error reporting mechanism in a wireless network does not require a user equipment (UE) to seek an alternative path to report an error once a connection problem has been detected as the UE would typically wait until the network connection is reestablished before reporting the error. Therefore the present disclosure proposes taking advantage of the existing network diversity to seek an alternative avenue to report the network error immediately once a reportable problem has been detected by the UE. By requiring the UE to seek to connect to at least one other different type of network in order to report the error immediately, the UE would provide valuable and necessary information for a mobile network operator to cope with network connection failures closer to real time in order to perform subsequent optimizations and problem mitigations. A mobile network operator may subsequently perform counter measures including reassigning the UE to a different network, preventing the UE to reconnect to the same network as long as the problem still occurs, to prevent others UE to connect to the same network, and to inform other UEs the network problem so that other UEs may to connect to a network on their own initiatives. The serving base station or access point transmit information to UEs under its serving domain to inform the UEs the cause of the problem and may also transmit control signaling to reconfigure the UEs for future accesses.

Therefore, the present disclosure proposes a network diversity based error reporting method to be used by a user equipment (UE) in the event of a network error, and the method includes the steps of establishing a first connection with a first network, establishing a second connection with a second network which is a different type of network from the first network, establishing a first failure report corresponding to the first connection in response to failing to connect with the first network, transmitting through the second connection the first failure report to the second network in response to establishing the first failure report, establishing a second failure report corresponding to the second connection in response to failing to connect with the second network, and transmitting through the first connection the second failure report to the first network in response to establishing the second failure report.

In general, the first network can be WLAN, and the second network can be cellular and vice versa. When UE experiences a problem with the first network, the UE would transmit a failure report immediately using the second work. Similarly, when the UE experiences a problem with the second network, the UE would transmit a failure report immediately using the first network. It should be noted that the first network is a different type of network from the second network.

For the present disclosure, the examples of WLAN and cellular networks would be used; however, it would be apparent for one skilled in the art that the present disclosure could also be applied to other types of networks. A WLAN could be defined based on the 802.11 family of protocols. A WLAN set up may include a hub or a router providing interconnectivities (e.g. intranet) among a group of UEs, and the hub or the router may connect to a modem which may provide connectivities to a Core Network through a gateway. A cellular network in the present disclosure could refer to a radio access network (RAN) through which UEs would be able to connect to a Core Network. A RAN could be defined according to a current or a future LTE standard, or the RAN could be defined according to existing standards such as GSM, UMTS, and etc.

In one of the exemplary embodiments, the first network is a WLAN and the second network is a cellular network, and after establishing said second connection with said second network, the UE would transmit wireless data through said first connection using the WLAN and transmit wireless data through the second connection using the cellular network. In other words, the UE could be assumed to have active connections with both a WLAN and a cellular network and is transmitting data using both connections before a network error occurs in one of the two networks.

In one of the exemplary embodiments, said first failure report may include at least but not limited to a location information and a signal source information. The location information may include a basic service set identification (BSSID), and the signal source information may include a signal strength and a signal quality information of an access point which provides wireless service to the UE.

In one of the exemplary embodiments, establishing the second failure report may further involve measuring from a neighboring cell to gather a cellular information of the neighboring cell. The cellular information may include information such as an operating frequency, a measured signal strength, and a measured signal quality of the neighboring cell.

In one of the exemplary embodiments, said second failure report may further include said cellular information of the neighboring cell, a location information, and a signal source information. The location information of the second failure report may include a physical cell identifier of a base station which provides wireless service to the UE, and the signal source information of the second failure report would include a signal strength and a signal quality information of the signal source of said base station.

In one of the exemplary embodiments, the UE establishing the second connection with the second network further could be the consequence of receiving a first signaling request from the first network which is a WLAN for the purpose of connecting to the second network which is a cellular network. This could occur if the WLAN decides to offload the UE to a cellular network based on its own initiative or based on a command from a mobile network operator. In response to receiving the first signaling, the UE would initiating the second connection to the cellular network in response to the first signaling request while maintaining the first connection.

In one of the exemplary embodiments, the UE would determine that a connection problem or failure has occurred when a signal strength or a signal quality of an access point of the first network falls below a non-zero threshold.

In one of the exemplary embodiments, the first failure report describing the failing of the first network is not only transmitted through the second connection to the second network but also is transmitting through the first connection to the first network.

In one of the exemplary embodiments, the UE connecting to the first network which is a WLAN is the result of receiving a second signaling request from the second network which is a cellular network for the purpose of connecting to the first network. This could occur when a base station transmit a signaling to offload the UE to a WLAN. In response to receiving the second signaling request, the UE would initiate the first connection to the WLAN while maintaining the second connection instead of severing the second connection.

The UE would determine that a failing or a problem with a cellular network has occurred when a signal strength or a signal quality of the serving base station of the second network falls below a non-zero threshold during a RRC measurement event.

In one of the exemplary embodiments, the second failure report would not only be transmitting to the first network, the second failure report would also be transmitted through the second connection to the second network.

The present disclosure proposes a user equipment (UE) which includes at least but not limited to a first transceiver for transmitting and receiving wireless data, a second transceiver for transmitting and receiver wireless data, a processing circuit coupled to the first transceiver and the second transceiver and is configured for establishing a first connection with a first network using the first transceiver, establishing a second connection with a second network which is a different type of network from the first network using the second transceiver, and establishing a first failure report corresponding to the first connection in response to failing to connect with the first network, transmitting through the second connection the first failure report to the second network using the second transceiver in response to establishing the first failure report, establishing a second failure report corresponding to the second connection in response to failing to connect with the second network; and transmitting through the first connection the second failure report to the first network in response to establishing the second failure report using the first transceiver.

The present disclosure also proposes a communication system which includes at least but not limited to a user equipment (UE), a wireless local area network (WLAN), and a cellular network, and the system would be configured to execute functions including the UE establishing a first connection with a WLAN and a second connection with the cellular network, the UE establishing a first failure report corresponding to the first connection in response to failing to connect with the WLAN, the UE transmitting through the second connection the first failure report to the cellular network in response to establishing the first failure report, the UE establishing a second failure report corresponding to the second connection in response to failing to connect with the cellular network, and the UE transmitting through the first connection the second failure report to the WLAN in response to establishing the second failure report.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a UE waiting to report the radio link failure information to a network until the UE re-establishes RRC connection with the network.

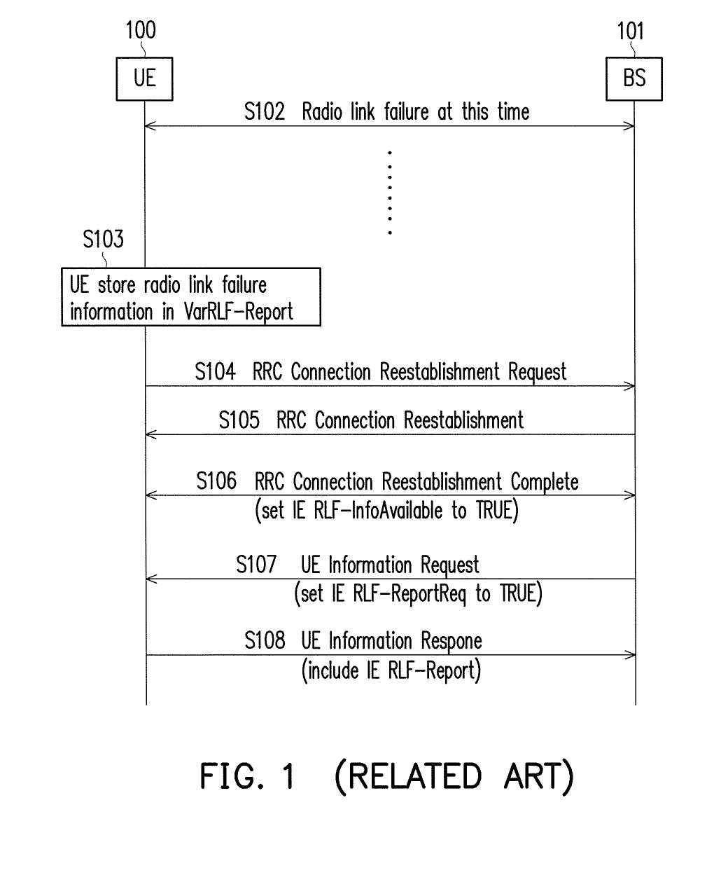

FIG. 2A is a conceptual diagram illustrating a network diversity based error reporting method in accordance with one of the exemplary embodiments of the present disclosure.

FIG. 2B is a conceptual diagram illustrating a network diversity based error reporting method in accordance with one of the exemplary embodiments of the present disclosure.

FIG. 3A illustrates a network diversity based error reporting method in accordance with one of the exemplary embodiments of the present disclosure.

FIG. 3B illustrates a network diversity based error reporting method in accordance with one of the exemplary embodiments of the present disclosure.

FIG. 4A illustrates a specific scenario of the error reporting method in response to a cellular network problem in accordance with one of the exemplary embodiments of the present disclosure.

FIG. 4B illustrates a specific scenario of the error reporting method in response to a WLAN network problem in accordance with one of the exemplary embodiments of the present disclosure.

FIG. 5A illustrates the proposed error reporting method in response to a WLAN connection problem in a handover scenario in accordance with one of the exemplary embodiments of the present disclosure.

FIG. 5B illustrates the proposed error reporting method in response to a cellular network connection problem in a handover scenario in accordance with one of the exemplary embodiments of the present disclosure.

FIG. 6A illustrates a specific scenario of the error reporting method to both networks in response to a cellular network problem in accordance with one of the exemplary embodiments of the present disclosure.

FIG. 6B illustrates a specific scenario of the error reporting method to both networks in response to a WLAN network problem in accordance with one of the exemplary embodiments of the present disclosure.

FIG. 7A illustrates a specific scenario of the error reporting method with a WLAN network connection problem in accordance with one of the exemplary embodiments of the present disclosure.

FIG. 7B illustrates a specific scenario of the error reporting method with a cellular network connection problem in accordance with one of the exemplary embodiments of the present disclosure.

FIG. 8A illustrates a specific scenario of the error reporting method among three different networks in accordance with one of the exemplary embodiments of the present disclosure.

FIG. 8B illustrates a specific scenario of the error reporting method among three different networks in accordance with one of the exemplary embodiments of the present disclosure.

### DETAILED DESCRIPTION OF DISCLOSED EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

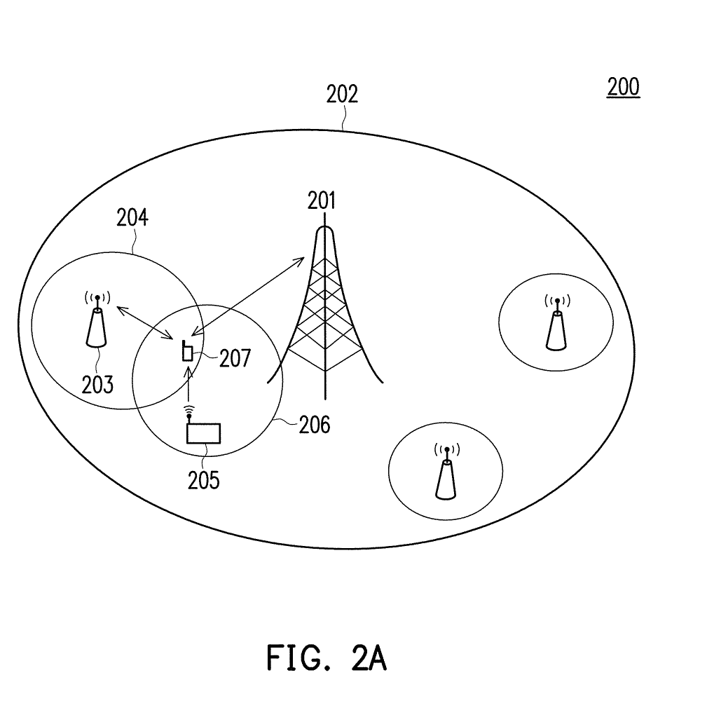

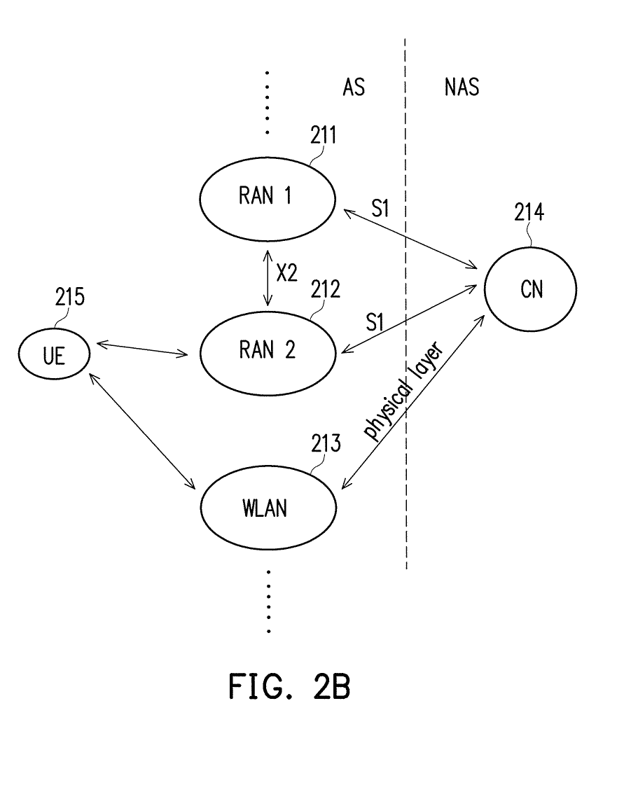

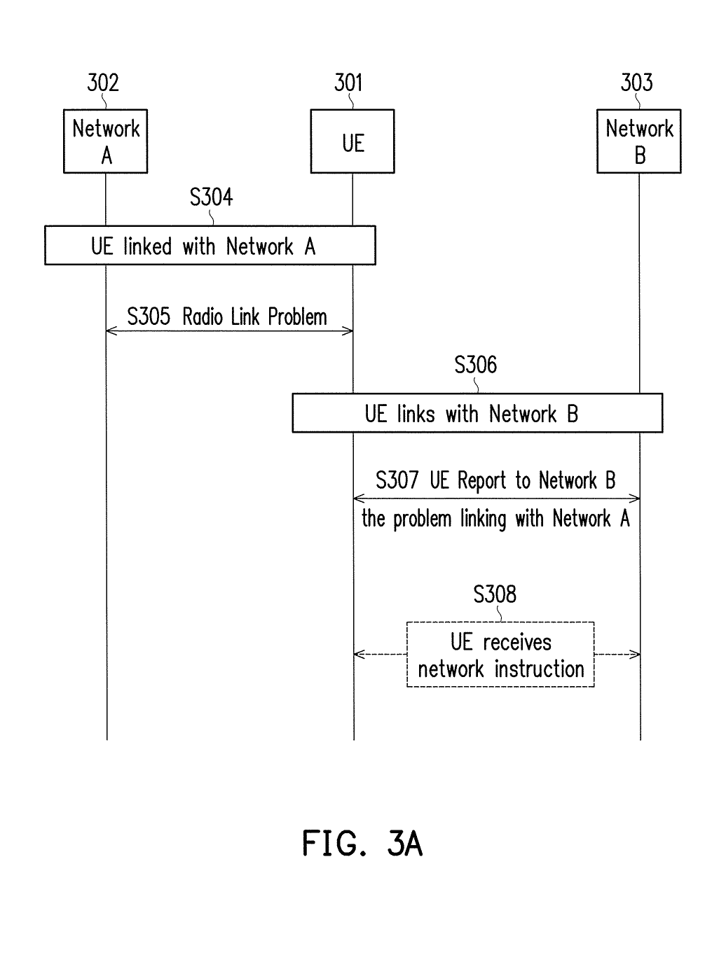

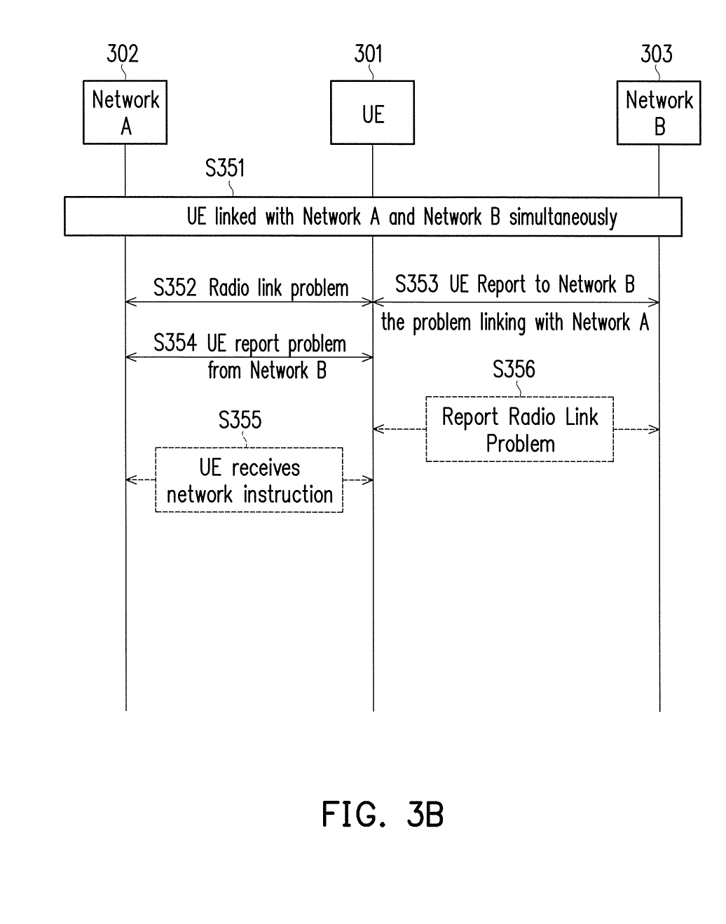

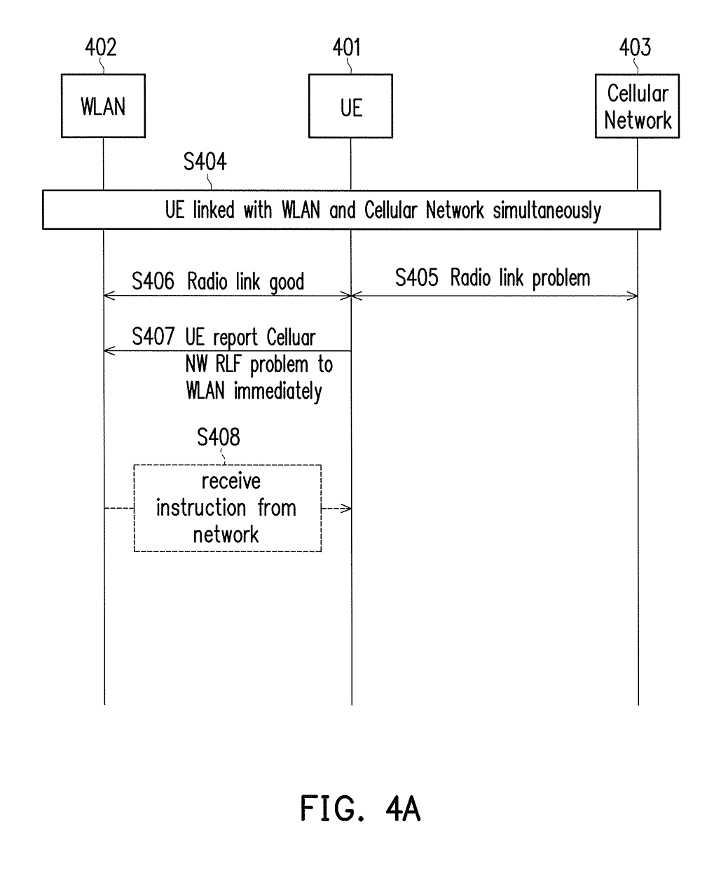

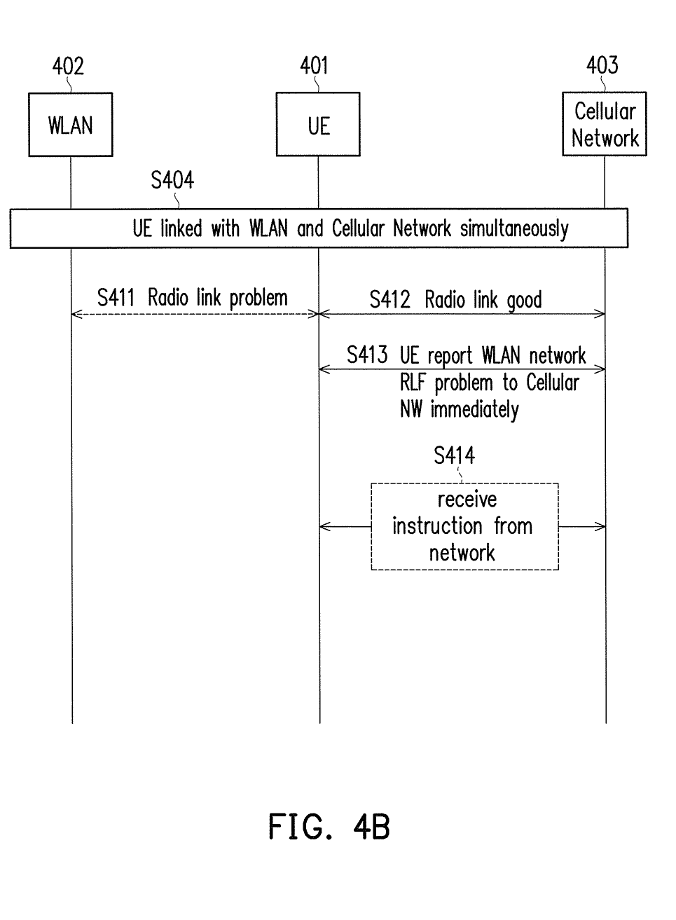

FIG. 2A˜2B are conceptual diagrams illustrating the proposed method in the system level. FIG. 3A˜3B are signaling diagrams which serve to conceptually illustrate the proposed method. FIG. 4A˜8B illustrates the proposed method under different specific scenarios.

FIG. 2A is a conceptual diagram illustrating a network diversity based error reporting method in accordance with one of the exemplary embodiments of the present disclosure. It should be noted that the specific setups of FIG. 2A˜2B are merely exemplary as it would be apparent to an ordinary person skilled in the art that the quantity and location of objects as well as the relative distances among the objects in these diagrams could vary and thus do not constitute limitations for the present disclosure. Currently, in just about any given location in a metropolitan city, there would be a base station 201 providing a wireless coverage within a specific range 202 under which various networks of the same or a different type could exist. The various networks could be various access point (AP) hotspots, or these could be small cell base stations such as micro, pico, or femto base stations. A mobile network operator may utilize these various networks to offload network data traffic in a congested area by reassigning UEs under its domain to one of these various networks. In this exemplary scenario, a UE 207 may obtain a network access through various means such as by connecting to the base station 201, by connecting to an WLAN access point 205 having a WLAN range 206, or by connecting to a small cell base station 203 having a micro cell range 204.

When the UE 207 falls within the coverage ranges 202, 204, 206 of the base station 201, the WLAN access point 205, and the small cell base station 203, the UE 207 of the present disclosure would be assumed to be able to achieve active connections to at least two or all three different types of networks and to transmit and receive wireless data at the same time. The advantage of doing such is fast and robust access to the intranet or internet as the UE or the network AP/base station may adjust bandwidths or timeslots of its connections according to the situations experienced by the networks. Under this scenario, assuming the UE 207 suddenly detects a problem connecting to the base station 201, the UE 207 does not have to wait until it reestablishes the connection with the base station before transmitting an error report. The UE 207 could very well transmit the error report to either the micro cell base station 203 or the WLAN access point 205.

However, the UE 207 does not have to already in multiple active connections in order to utilize proposed method. Suppose that the base station 201 has determined to offload the UE 207 to a WLAN access point 205, the UE 207 would receive a signaling command to re-assign the UE 207 to the WLAN access point 205. In the case when a hard handover technique is utilized, the UE 207 would severe its connection with the base station 201 first before connecting to the WLAN 205. Subsequently when the UE fails to establish an adequate connection with the WLAN 205, the UE may immediately reestablish a connection with the base station 201 and transmit an error report. In the case when a soft handover technique is utilized, the UE 207 would maintain an active connection with the base station 201 for a brief period of time during which the UE 207 would transmit an error report to the base station 201 when the UE 207 has determined that it has failed to establish an adequate connection with the WLAN 205.

In another similar scenario, suppose that the UE 207 is actively transmitting data with both the base station 201 and the WLAN 205 and subsequently determines that a problem has occurred with the WLAN 205 connection, the UE 207 would not only transmit data to the base station 201 but also to the WLAN 205. The advantage of such is that by transmitting error report to two or more different networks, the error report would be received by the mobile network operator sooner, and any subsequent optimization could be performed closer to real time.

FIG. 2B illustrates another exemplary scenario using a network block diagram. In this scenario, a UE may connect to a radio access network1 (RAN 1) 211, RAN2 212, or a WLAN 213 in the access stratum (AS). One of the RAN1 211 and RAN2 212 could an evolved node B (eNB) and the other could be the same or a different type of network such as GSM or UMTS. RAN1 211 and RAN2 212 could be interconnected through an inter-base station interface such as X2 interface, and RAN1 211 and RAN2 212 could be connected to a Core Network 214 in the non access stratum (NAS) through a backhaul link such as a S1, Lu, or Gb interface. The WLAN 213 could be connected to the Core Network 214 via any existing physical layer protocol or a higher protocol such as TCP/IP. The actual protocol for the case of LTE could be referred to 3Gpp TS 36.331. Assuming that the UE 215 is actively connected to RAN2 212 and WLAN 213, the UE 215 may transmit an error report to WLAN 213 if a connection with RAN2 212 is less than optimal, and the UE may transmit an error report to RAN2 212 if a connection with WLAN 213 is less than optimal. If all else fails, the UE 215 yet look for another connection such as RAN 1 211 to transmit the error report.

Upon the WLAN 213 receiving an error report concerning RAN 2 213, WLAN 213 may deliver the report to the Core Network via the backhaul link. The Core Network 214 may then take steps to mitigate the situation. For example, the Core Network 214 may prevent the UE 215 from connecting to RAN2 212. The Core Network 214 may transmit a SMS message to UEs under the domain of RAN2 212 or to inform these UEs through paging messages and system information blocks. The Core Network 214 may reassign the UE 215 to RAN1 211 or to another nearby small cell base station. The Core Network 214 may also prevent some or all UEs under the domain of RAN2 212 from connecting with RAN2 212 and reassigning them to other networks such as RAN1 or WLAN 213 until the problem is resolved. Also, the aforementioned steps to mitigate the situation could be performed by a RAN2 which would coordinate with other RANs over an inter-base station interface to mitigate the problem.

The proposed method would be described by signaling flow charts. FIG. 3A illustrates a network diversity based error reporting method in accordance with one of the exemplary embodiments of the present disclosure. In step S304, a UE 301 would connect to network A 302 and actively transmit and receive data with network A 302. In step S305, the UE 301 has determined that a radio link problem exist in its connection with Network A 302. The radio link problem could be demarcated into at least two categories. One would be a failure to connect as the UE 301 all in a sudden cannot connect to Network A 302. The other would be a decrease in signal strength and/or signal qualities of the signal source. When the signal strength and/or signal qualities drop below a threshold, the UE 301 would consider such circumstance as a network failure or problem. In response to a network failure and after a certain number of re-tries, in step S306, the UE 301 would immediately take action to establish a connection with another network such as network B 303 instead of waiting for the connection to be re-established with Network A 302. Upon establishing the connection with network B 303, in step S307 the UE 301 would immediately report the network problem of Network A 302 to the Network B 303. In step S308, the UE 301 may receive an instruction initiated from the Core Network 214 or from Network B 303 itself as to how to proceed.

FIG. 3B illustrates a network diversity based error reporting method in accordance with one of the exemplary embodiments of the present disclosure. This exemplary scenario is very similar to FIG. 3A except that in step S351, the UE 301 has already established an active status with both Network A 302 and Network B and has been transmitting and receiving from both Network A 302 and Network B. Active connection for the case of cellular network would mean that the UE 301 is in RRC Active status instead of RRC Idle. Steps S352˜S355 would be the same as step S305˜308 and thus a repetitive written description is not made.

FIG. 4A illustrates a specific scenario of the error reporting method in response to a cellular network problem in accordance with one of the exemplary embodiments of the present disclosure. In this exemplary scenario, in step S404, a UE 401 is assumed to be already actively connected to a WLAN 402 and a cellular network 403 and is transmitting and receiving wireless data using both networks. In step S405, the UE 401 comes to a conclusion that its radio link with the cellular network 403 is problematic which means that the radio link ceases to exist or the signal strength and/or quality of the serving base station of the cellular network 403 is below an acceptable threshold. When the UE 401 is unable to connect to the cellular network, the UE 401 may perform a number of re-tries and/or the UE 401 may read the system information and finds out that it has been access barred by the cellular network 403. Meanwhile in step S406, the UE 401 at almost the same point in time comes to the conclusion that its radio link with the WLAN 402 is adequate. In step S407, the UE 401 would report to the cellular network 403 a radio link failure (RLF) Report to the WLAN 402 immediately.

The RLF report would contain at least but not limited to one of three following components. The first component is the signal strength and the signal quality of the serving base station of the cellular network 403. For example, in the case of LTE, the RLF report would include a reference signal received power (RSRP) and a reference signal received quality (RSRQ) indicator. Reference signal receive power (RSRP) would be a physical layer measurements performed by the UE 401 and is the average power of the downlink reference signals (RS) across a channel bandwidth. Reference signal receive quality (RSRQ) would be the ratio between the RSRP and received signal strength indicator (RSSI) of a E-UTRA carrier measured by the UE 401. In order to establish the RLF report, the UE 401 would make physical layer measurements of the parameters as described. The actual measurement definitions could be referred to 3GPP specifications such as TS 36.214. Similar to the case LTE, for a UMTS network the UE 401 perform measures to obtain parameters include a reference signal code power (RSCP) and a received power to interference ratio (Ec/Io).

A second component to be included in the RLF report would be a UE measured neighbor cellular information which would include cellular information of one or more neighboring cells, and for each neighboring cell the UE 401 would determine the operating frequency of a neighboring cell as well as the measured signal strength and signal quality of the neighboring cell. This would mean that the UE 401 would also perform these measurements before the RFL report could be established.

A third component to be included in the RLF report would be the location information of the serving base station. The location information would include at least one of the approximate time of failure, cell global identification (ID) of the failed cell, the physical cell ID, the location of the UE, and the approximate time of the access barring experienced by the UE. Having one or more of these three components in the RLF would provide valuable information for the core network or the WLAN acting alone to react to the failure of the cellular network S403. In order to mitigate the network failure of the cellular 403, the WLAN in step S408 would transmit an instruction to the UE 401 to take necessary steps. These steps have been described previously and thus a repetition would not be necessary.

It should be noted that the network failure or problem as previously described may not be the failure of the actual cellular network such as 403 or the serving base station. In some cases, the failure is the failure of the connection (e.g. due to multi-path signal) rather than the failure of the network.

Similar to FIG. 4A, FIG. 4B illustrates an exemplary scenario in which the error reporting method is utilized in response to a WLAN network problem. In step S404, the UE 401 has established connection with WLAN 402 and a cellular network 403. In step S411, the UE has experienced a radio link problem with the WLAN 402 while the radio link with the cellular network 403 is adequate. In step S413, in response to the radio link problem with WLAN 402, the UE 402 would transmit a RLF report to the cellular network 403 immediately. In step S414, the UE 401 may receive via the cellular network 403 an instruction indirectly from the Core Network 214 or indirectly from another eNB coordinating with nearby eNBs through the inter-eNB interface such as X2 to collectively cope with the radio link problem.

For the scenario of FIG. 4B, the RLF report transmitted to the cellular network 403 in step S413 would include at least one of the two following components. One component is the signal strength and signal quality of the AP of the WLAN network. The signal strength and quality would be measured by the UE 401. The other component would include at least one of the approximate time of failure detected by the UE 401 and the failed basic service set identification (BSSID), and the location of the UE 401.

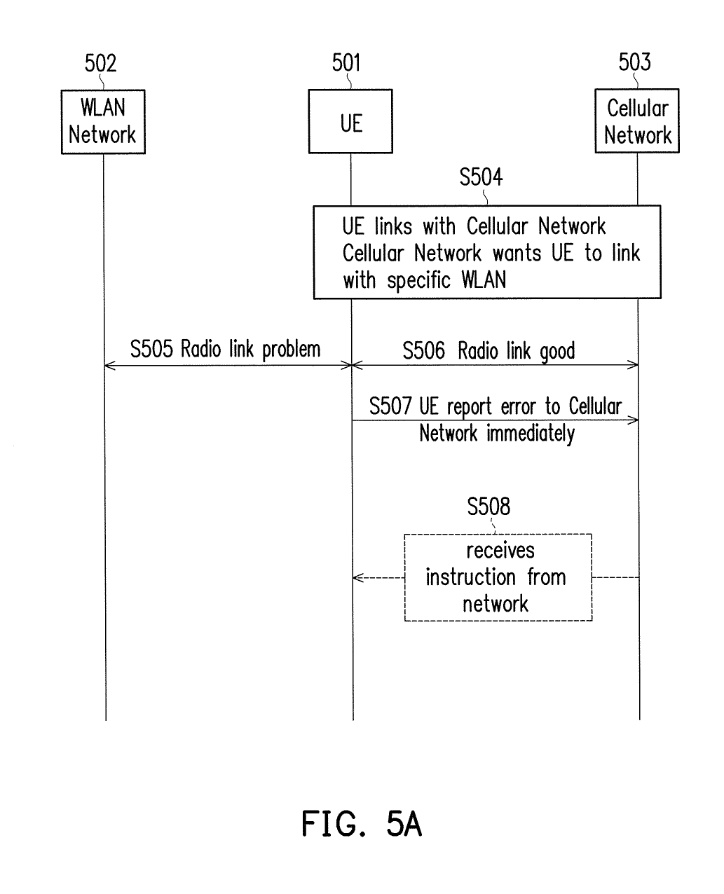

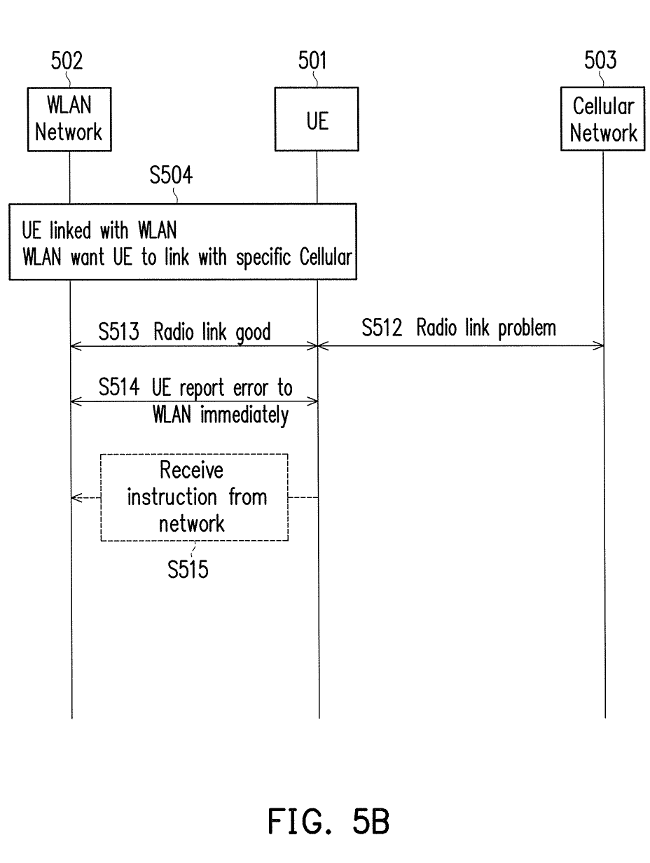

FIG. 5A illustrates the proposed error reporting method in response to a WLAN connection problem in a handover scenario in accordance with one of the exemplary embodiments of the present disclosure. The handover could be the result of offloading by the serving base station of the cellular network 503 or mobility of the UE 501. However, handover does not necessarily mean that the UE 501 would severe its connective relationship with the cellular network 503. The UE 501 may simply maintain its active relationship with the cellular network 503 while attempting to connect to the WLAN 502 since a WLAN is typically faster. The UE 501 may choose to divide its bandwidth between the cellular network 503 and the WLAN 502 to transmit and receive data at maximum capacity. In another scenario however, before or after steps S505 and S506, the UE may choose to severe its connective relationship with the cellular network 503 in order to preserve power. In step S501, the UE 501 has previously established an active connection with the cellular network 503 which has transmitted a signaling to inform the UE 501 to reconnect to a WLAN 502. In step S506, while the radio link between the UE 501 and the cellular network 503 has been acceptable, in step S505 the UE 501 after receiving a handover command could not establish a connection with the WLAN 502 or could not establish a connection with sufficient signal strength and quality. In response to the radio link problem in step S505, in step S507 the UE 501 would transmit the RLF report to the cellular network 503 immediately. In step S508, the UE 501 may receive an instruction from the cellular network 503 as for how to proceed.

For the exemplary scenario of FIG. 5A, RLF report in addition to the at least one of the two components previously mentioned for FIG. 4B, the RLF report would further include the error cause of the failed connection. The error cause may contain at least one of two elements. The first element is the UE not being able to locate the WLAN having a specific BSSID. In that case, the UE received a handover command to connect to a WLAN having a specific BSSID but could not locate the device. The second element is an indicator or a flag indicating that the measured signal of the WLAN with the specific BSSID is below a predetermined threshold.

FIG. 5B illustrates the proposed error reporting method in response to a cellular network connection problem in a handover scenario in accordance with one of the exemplary embodiments of the present disclosure. In step S511, the UE 501 has established an active connection with the WLAN 502, and a network control node such as the mobility management entity (MME) in the Core Network 214 has informed the WLAN 502 that the UE 501 is to be handed over to a cellular network 503. Or the WLAN 502 may decide to hand the UE 501 over to the cellular network 503 based on its own volition. In step S513, while the radio link between the WLAN 502 and the UE 501 has been adequate, after receiving a handover command to be handed over the cellular network 503, the UE 501 in step S512 fails to establish a connection with the cellular network 503 or fails to establish a connection with sufficient signal strength and signal quality with the cellular network 503. In response to the radio link problem in step S512, in step S514, the UE 501 immediately transmit a RLF report to the WLAN 502. In step S515, the UE 501 receives further instruction from the WLAN 502.

For the exemplary scenario of FIG. 5B, RLF report in addition to the at least one of the three components previously mentioned for FIG. 4A, the RLF report would further include the error cause of the failed connection. The error cause may contain at least one of three elements. The first element is the UE not being able to locate the cellular network with a specific cell ID. The second element is an indicator or a flag indicating that the measured signal of the cellular network with the specific BSSID is below a predetermined threshold. The third element is that the UE 501 is currently under an access bar imposed by the serving base station.

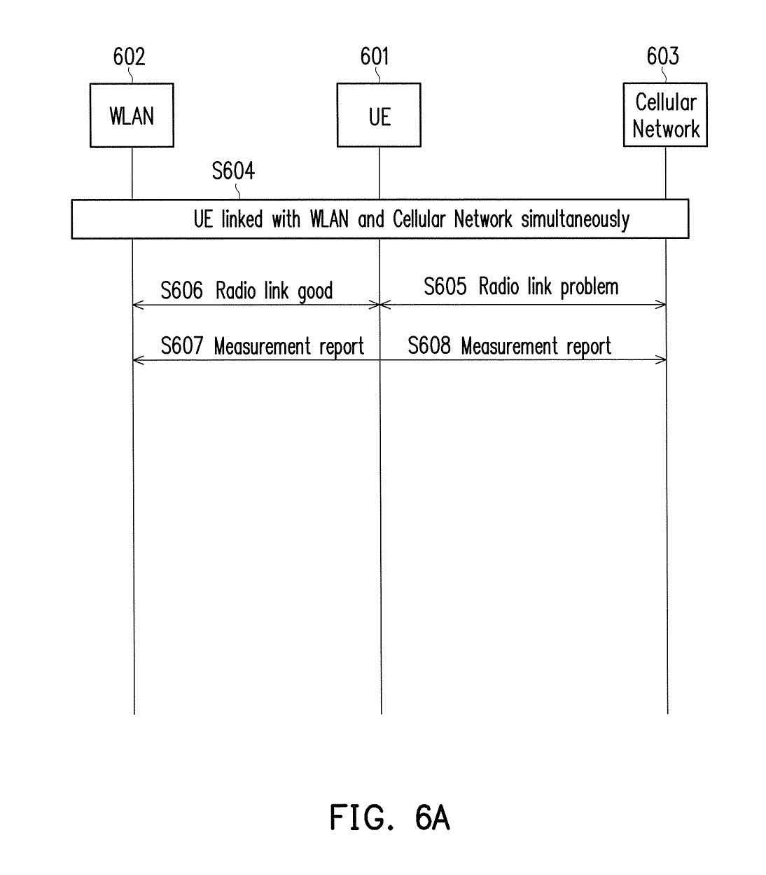

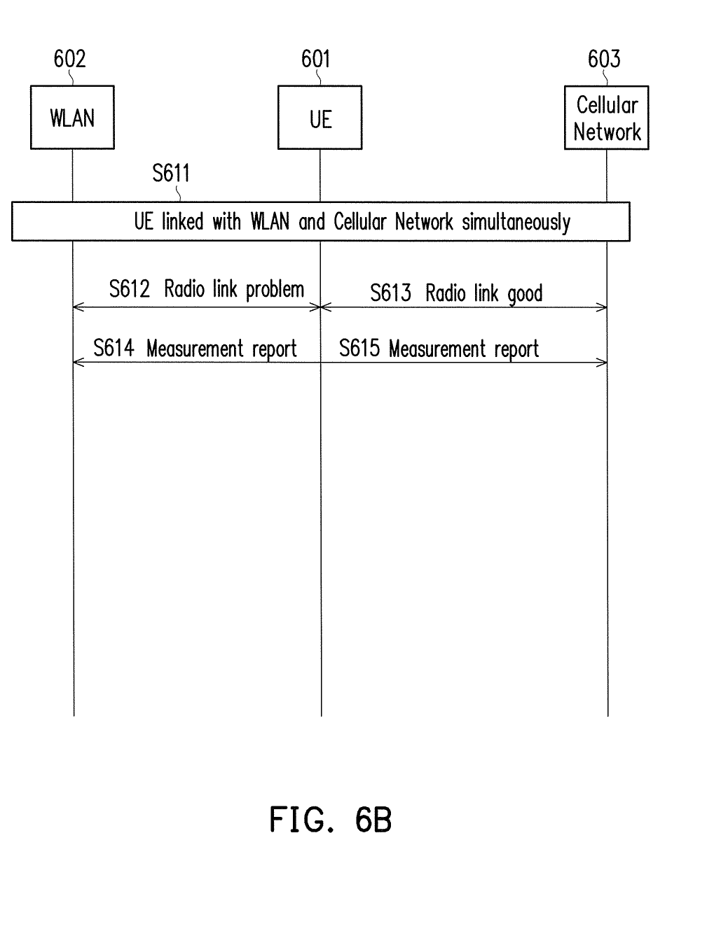

FIG. 6A illustrates a specific scenario of the error reporting method to both networks in response to a cellular network problem in accordance with one of the exemplary embodiments of the present disclosure. In step S604, the UE 601 has previously established an active connection with both the WLAN 602 and the cellular network 603 and has been transmitting and receiving data via both the WLAN 602 and the cellular network 603. In step S606, while the radio link between the UE 601 and the WLAN 602 has been adequate, the radio link in step S605 between the UE 601 and the cellular network 603 has been determined to be below an acceptable threshold during a RRC measurement event. In response to the radio link problem, in steps S607, the UE 601 would transmit a measurement report to the WLAN 602. The UE 601 however would also transmit the measurement report to the cellular network 603. The content of the measurement report could also include at least one of the three components of the RLF report mentioned for FIG. 4A.

FIG. 6B illustrates a specific scenario of the error reporting method to both networks in response to a WLAN problem in accordance with one of the exemplary embodiments of the present disclosure. Step S611 would be the same as step S604. In response to a radio link problem in step S612 while the quality of the radio link has been above an acceptable threshold in step S613, the UE 601 would transmit a measurement report to WLAN 602 in step S614 and a measurement report to the cellular network in step S615.

For the exemplary scenario of FIG. 6A and FIG. 6B, as soon as the UE 601 detects a perform drop below a certain standard, in other words, the signal strength and signal quality of the signal resource from either the AP of the WLAN 602 or the serving base station of the cellular network 603 falls below an acceptable threshold or the UE 601 detects some kind of interference from another alien source, the UE 601 would react by immediately transmitting a measurement report to both the WLAN 602 and the cellular network 603. The measurement report transmitted to the WLAN 602 could contain the at least one of the three components as described for FIG. 4A, and the measurement report transmitted to the cellular network 603 could contain the at least one of the two components as described for FIG. 4B. Therefore, as soon as the UE 601 detects a performance drop in one of the two connections, by transmitting a measurement report to both the WLAN 602 and the cellular network 603, both networks would directly receive the measurement report immediately from the UE and thus would be able to react to the drop of the system performance quicker.

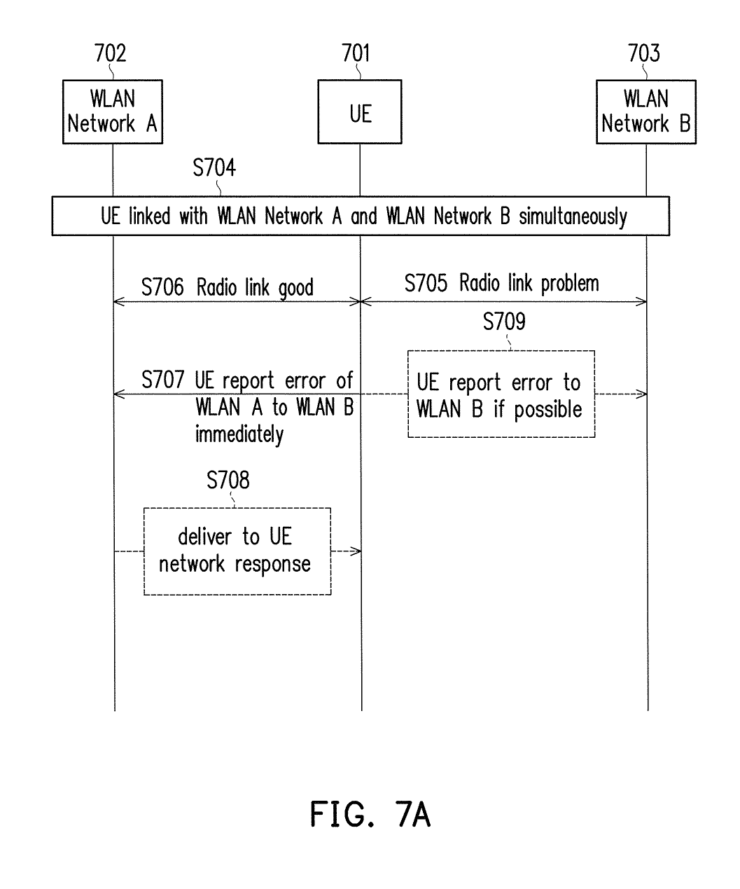

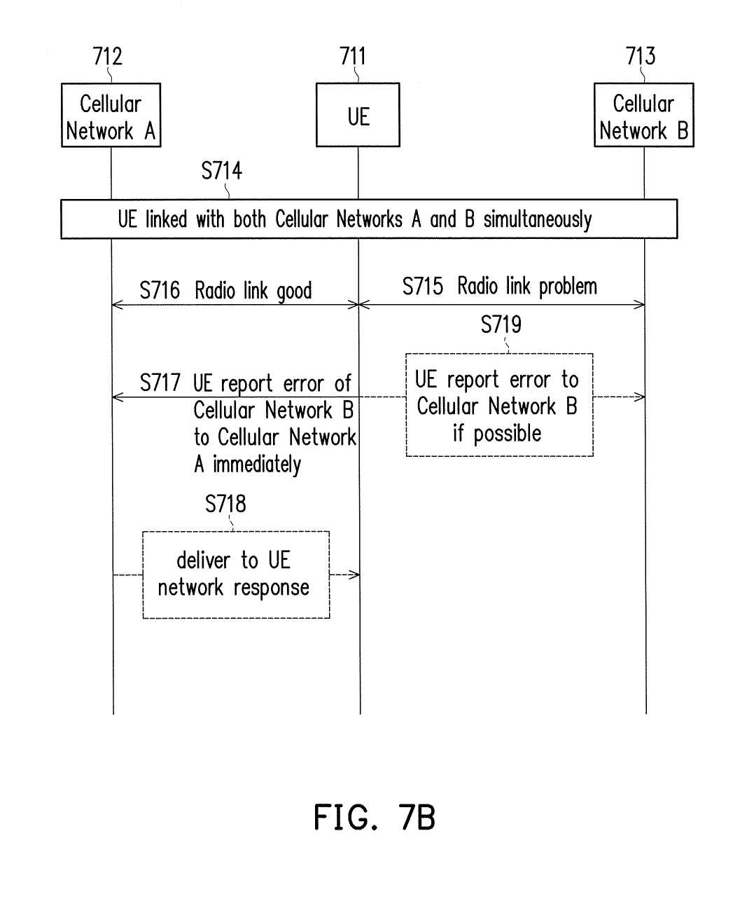

FIG. 7A illustrates the error reporting method based on an application of the specific scenario of FIG. 3B. In step S704, the UE 701 would connect to two different WLAN access points simultaneously. For example, if a UE is located at a campus having a coffee shop nearby, the UE at the coffee shop may connect to the both the WLAN at the coffee shop or the WLAN of the campus. At this point in time, the UE may use two different network cards with one for each different WLAN connection. In this way, existing WLAN standard and infrastructure could be utilized without requiring drastic changes. In step S704, the UE 701 would be actively connected with WLAN A and WLAN B simultaneously. In step S706, while the connection with WLAN A is adequate, the connection with WLAN B is sub-par. In response to the radio link problem of the connection with WLAN B, in step S707, UE 701 would transmit a RLF report to WLAN A to report the radio link problem with WLAN B. In step S709, the UE 701 may also transmit the same RLF report to WLAN B. In step S708, the UE 701 may receive an instruction from WLAN A as for how to proceed in order to cope with the radio link problem with WLAN B.

Similar to FIG. 7B, FIG. 7A illustrates the error reporting method based on an application of the specific scenario of FIG. 3B except both networks are cellular networks. In step S714, the UE 711 has been in active connection with both cellular network A 712 and cellular network B 713. In step S715, the radio link with cellular network B has dropped below an acceptable threshold while in step S716 the radio link with cellular network A has been adequate. In step S717, the UE 711 would immediately transmit an error report such as a RLF report to cellular network A 712. In step S719, the UE 711 may also transmit the same error report the cellular network B 713. In step S718, the UE 711 would receive a response delivered from cellular network A 712.

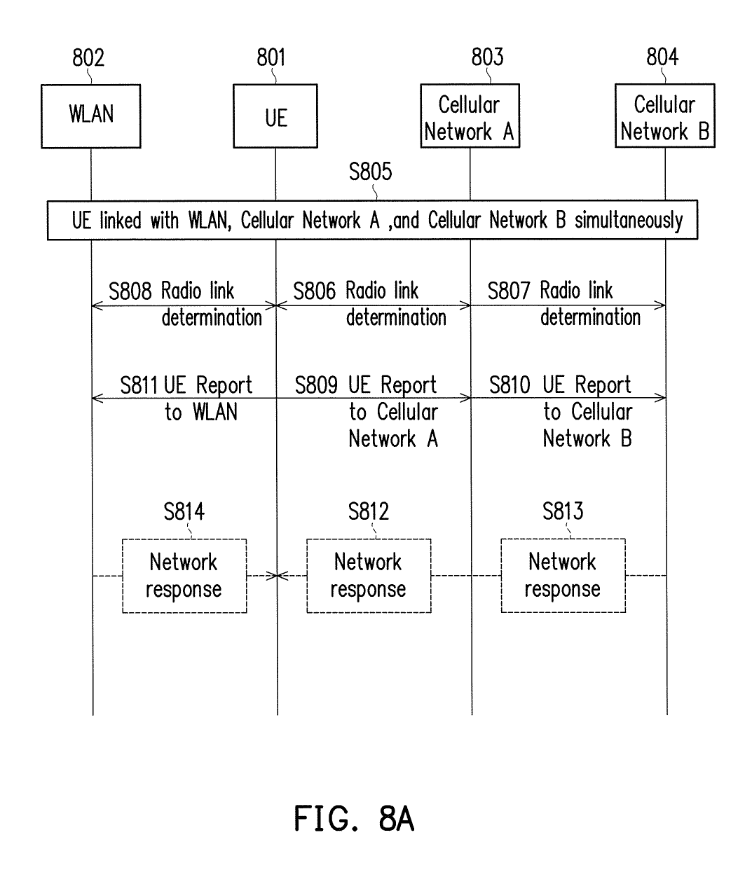

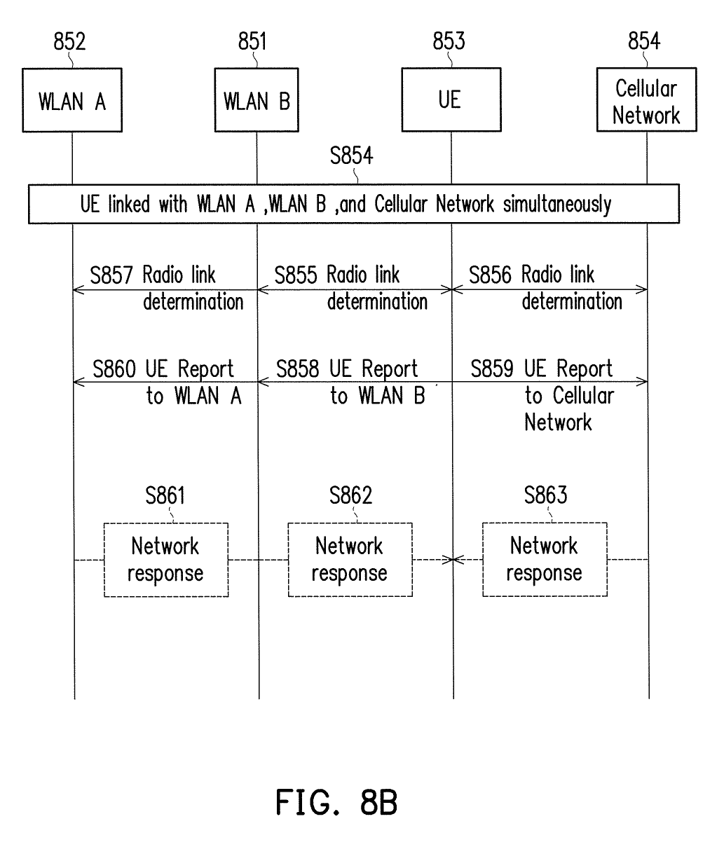

The aforementioned disclosure thus far could be extended to the scenario when a UE 801 would simultaneously connect to more than two different networks. FIG. 8A illustrates an exemplary scenario of the error reporting method among three different networks simultaneously with one being a WLAN 801 and the other two being two different cellular networks such as cellular network A 803 and cellular network B 804. For the scenario involved coordinated multi-point (Comp), cellular network A 803 and cellular network B 804 would appear as a single base station for the UE 801 and thus the error reporting mechanism under this particular scenario could be very similar to a UE 801 simultaneously connecting to a WLAN and a cellular network. Under a non-Comp scenario, it would be possible for a UE 801 to connect to a WLAN 802 while the cellular network A 803 is in a soft handover process to offload the UE 801 over to the cellular network B 804.

In step S805, the UE has been actively linked with WLAN 802, cellular network A 803, and cellular network B 804. In steps S806˜S808, the UE determines whether any of the three connections has failed or is sub-par. In steps S809˜S811, in response to detecting at least one radio link problem with one of the three networks, the UE would transmit a RLF report to the other different networks through the other two adequate radio links immediately. The UE may also transmit the RLF report to all three different networks. In steps S812˜S814, the UE may receive a response to mitigate the radio link problem.

FIG. 8B illustrates a specific scenario of the error reporting method among three different networks in accordance with one of the exemplary embodiments of the present disclosure. Similar to FIG. 8A, the exemplary scenario involves a UE 853 connecting with two WLANs and one cellular network. In step S854, the UE 853 is actively connecting with WLAN A 852, WLAN B 851, and the cellular network 854. steps S855˜S863 would be the same as steps S806˜S814 and thus the same description would not be repeated.

In this disclosure, WLAN or 3GPP-like keywords or phrases are used merely as examples to present inventive concepts in accordance with the present disclosure; however, it could be apparent that the same concept presented in the disclosure may possibly be extended to any other systems such as IEEE 802.16, WiMAX, or so like by persons of ordinarily skilled in the art.

A base station in this disclosure may also include base stations such as an advanced base station (ABS), a base transceiver system (BTS), a node B, an evolved node B (eNB), a home eNB, a macro base station, a pico base station, a femto base station, an access point, a home base station, a relay station, a repeater, an intermediate node, an intermediary, and/or satellite-based communication base stations.

From the hardware perspective, a base station may include at least but not limited to a transmitter circuit, a receiver circuit, an analog-to-digital (A/D) converter, a digital-to-analog (D/A) converter, a processing circuit, one or more antenna units, and optionally a storage medium. The transmitter and the receiver transmit downlink signals and receive uplink signals wirelessly. The receiver may include functional elements to perform operations such as low noise amplifying, impedance matching, frequency mixing, down frequency conversion, filtering, amplifying, and so forth. The transmitter may include function elements to perform operations such as amplifying, impedance matching, frequency mixing, up frequency conversion, filtering, power amplifying, and so forth. The analog-to-digital (A/D) or the digital-to-analog (D/A) converter is configured to convert from an analog signal format to a digital signal format during uplink signal processing and from a digital signal format to an analog signal format during downlink signal processing.

The processing circuit is configured to process digital signal and to perform functions, processes or procedures, or method steps of the proposed method in exemplary embodiments of the present disclosure. Also, the processing circuit may optionally be coupled to a memory circuit to store programming codes, device configurations, a codebook, buffered or permanent data, and etc. . . . The functions of the processing circuit may be implemented using programmable units such as a micro-processor, a micro-controller, a DSP chips, FPGA, etc. The functions of the processing circuit may also be implemented with separate electronic devices or ICs, and the processing circuit may also be implemented with either hardware or software.

The term “user equipment” (UE) in this disclosure could represent various embodiments which for example could include but not limited to a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and so like. In some applications, a UE may be a fixed computer device operating in a mobile environment, such as a bus, train, an airplane, a boat, a car, and so forth.

From the hardware perspective, a UE may includes at least but not limited to a transmitter circuit, a receiver circuit, an analog-to-digital (A/D) converter, a digital-to-analog (D/A) converter, a processing circuit, one ore more antenna units, and optionally a memory circuit. The memory circuit may store programming codes, device configurations, buffered or permanent data, codebooks, and etc. . . . The processing circuit may also be implemented with either hardware or software and would be considered to implement the functions, processes or procedures, and method steps of embodiments of the present disclosure. The function of each element of a UE is similar to a base station and therefore detailed descriptions for each element will not be repeated.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

In all the drawings of the present disclosure, a box enclosed by dotted lines would mean an optional functional element or an optional step, and a dotted line may mean that the process flow could be optional or may not necessarily occur.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A network diversity based error reporting method to be used by a user equipment (UE) in response to a network error, and the method comprising:
establishing a first connection with a first network;
establishing a second connection with a second network which is a different type of network from the first network;
establishing a first failure report corresponding to the first connection in response to failing to connect with the first network;
transmitting through the second connection the first failure report to the second network in response to establishing the first failure report;
establishing a second failure report corresponding to the second connection in response to failing to connect with the second network; and
transmitting through the first connection the second failure report to the first network in response to establishing the second failure report.

2. The method of claim 1, wherein the first network is a wireless local area network (WLAN) and the second network is a cellular network, and after the step of establishing the second connection with the second network, claim 1 further comprises:
transmitting wireless data through the first connection using the WLAN; and
transmitting wireless data through the second connection using the cellular network.

3. The method of claim 2, wherein the first failure report comprises a location information and a signal source information, wherein the location information of the first failure report comprises a basic service set identification (BSSID) and the signal source information of the first failure report comprises a signal strength and a signal quality information.

4. The method of claim 1, wherein the step of establishing the second failure report further comprises:
measuring from a neighboring cell to gather a cellular information comprising an operating frequency, a measured signal strength, and a measured signal quality of the neighboring cell.

5. The method of claim 4, wherein the second failure report further comprises the cellular information of the neighboring cell, a location information, and a signal source information wherein the location information of the second failure report comprises a physical cell identifier and the signal source information of the second failure report comprises a signal strength and a signal quality information.

6. The method of claim 1, wherein the step of establishing the second connection with the second network further comprises:
receiving a first signaling request from the first network which is a WLAN to connect to the second network which is a cellular network; and
initiating the second connection to the cellular network in response to the first signaling request while maintaining the first connection.

7. The method of claim 6, wherein the step of failing to connect with the first network is determined when a signal strength or a signal quality of the first network is below a non-zero threshold.

8. The method of claim 7, wherein transmitting through the second connection the first failure report to the second network in response to establishing the first failure report further comprises:
transmitting the first failure report through the first connection to the first network.

9. The method of claim 1, wherein the step of establishing the first connection with the first network further comprises:
receiving a second signaling request from the second network which is a cellular network to connect to the first network which is a WLAN; and
initiating the first connection to the WLAN in response to the second signaling request while maintaining the second connection.

10. The method of claim 9, wherein the step of failing to connect with the second network is determined when a signal strength or a signal quality of the second network is below a non-zero threshold during a RRC measurement event.

11. The method of claim 10, wherein transmitting through the first connection the second failure report to the first network in response to establishing the second failure report further comprises:
transmitting the second failure report through the second connection to the second network.

12. A user equipment (UE) comprising:
a first transceiver for transmitting and receiving wireless data;
a second transceiver for transmitting and receiver wireless data;
a processing circuit coupled to the first transceiver and the second transceiver and is configured for:
establishing a first connection with a first network using the first transceiver;
establishing a second connection with a second network which is a different type of network from the first network using the second transceiver;
establishing a first failure report corresponding to the first connection in response to failing to connect with the first network;
transmitting through the second connection the first failure report to the second network using the second transceiver in response to establishing the first failure report;
establishing a second failure report corresponding to the second connection in response to failing to connect with the second network; and
transmitting through the first connection the second failure report to the first network in response to establishing the second failure report using the first transceiver.

13. The UE of claim 12, wherein the processing circuit is further configured for:
transmitting wireless data using the first transceiver through the first connection to the first network which is a WLAN; and
transmitting wireless data using the second transceiver through the second connection to the second network which is a cellular network while maintaining the first connection.

14. The UE of claim 12, wherein the first failure report comprises a location information and a signal source information, wherein the location information of the first failure report comprises a basic service set identification (BSSID) and the signal source information of the first failure report comprises a signal strength and a signal quality information.

15. The UE of claim 12, wherein the processing circuit is further configured for:
measuring from a neighboring cell to gather a cellular information comprising an operating frequency, a measured signal strength, and a measured signal quality of the neighboring cell using the second transceiver.

16. The UE of claim 15, wherein the second failure report comprises the cellular information of the neighboring cell, a location information, and a signal source information wherein the location information of the second failure report comprises a physical cell identifier and the signal source information of the second failure report comprises a signal strength and a signal quality information.

17. The UE of claim 16, wherein the processing circuit is configured for establishing the second connection with the second network using the second transceiver further comprises:
receiving a first signaling request from the first network which is a WLAN using the first transceiver to connect to the second network which is a cellular network; and
initiating the second connection to the cellular network in response to the first signaling request using the second transceiver while maintaining the first connection.

18. The UE of claim 16, wherein the processing circuit is configured for establishing the first connection with the first network using the first transceiver further comprises:
receiving a second signaling request from the second network which is a cellular network to connect to the first network which is a WLAN using the second transceiver; and
initiating the first connection to the WLAN in response to the second signaling request using the first transceiver while maintaining the second connection.

19. The UE of claim 12, wherein the processing circuit is further configured for: transmitting the first failure report to both the first network and the second network using the first transceiver and the second transceiver respectively in response to failing to connect with the first network; and transmitting the second failure report to both the first network and the second network using the first transceiver and the second transceiver respectively in response to failing to connect with the second network.

20. A communication system comprising a user equipment (UE), a wireless local area network (WLAN), and a cellular network, wherein the system is configured for:
the UE establishing a first connection with a WLAN and a second connection with the cellular network;
the UE establishing a first failure report corresponding to the first connection in response to failing to connect with the WLAN;
the UE transmitting through the second connection the first failure report to the cellular network in response to establishing the first failure report;
the UE establishing a second failure report corresponding to the second connection in response to failing to connect with the cellular network; and
the UE transmitting through the first connection the second failure report to the WLAN in response to establishing the second failure report.
